(19) United States
(12) Patent Application Publication
(10) Pub. No.: US 2010/0214076 A1
(43) Pub. Date: Aug. 26, 2010

(54) APPARATUS FOR COMMUNICATING WITH RFID TAG

(75) Inventor: Kazutaka Yamamoto, Nagoya-shi (JP)

Correspondence Address: DAY PITNEY LLP, 7 TIMES SQUARE, NEW YORK, NY, 10036-7311, US

(73) Assignee: BROTHER KOGYO KABUSHIKI KAISHA, Nagoya-shi (JP)

(21) Appl. No.: 12/773,142

(22) Filed: May 4, 2010

Related U.S. Application Data
(63) Continuation-in-part of application No. PCT/JP2008/069530, filed on Oct. 28, 2008.

(30) Foreign Application Priority Data
Nov. 12, 2007 (JP) 2007-293273

(51) Int. Cl. H04Q 5/22

(52) U.S. Cl. 340/10.4

(57) ABSTRACT

This disclosure discloses an apparatus for communicating with an RFID tag comprising: an apparatus antenna configured to conduct radio communication with at least one RFID tag circuit element having an IC circuit part storing information and a tag antenna capable of transmission and reception of the information; a parameter obtainment portion configured to obtain communication parameter history information stored in a storage device and associated with tag identification information of each RFID tag circuit element; and a parameter setting portion configured to set a communication parameter for conducting information transmission and reception with the RFID tag circuit element by the apparatus antenna on the basis of the communication parameter history information obtained in the parameter obtainment portion.

### CROSS-REFERENCE TO RELATED APPLICATION

This is a CIP application PCT/JP2008/69530, filed Oct. 28, 2008, which was not published under PCT article 21(2) in English.

### BACKGROUND OF THE INVENTION

1. Field of the Invention

The present invention relates to an apparatus for communicating with an RFID tag that conducts radio communication with a radio frequency identification (RFID) tag circuit element provided with an IC circuit part storing information and a tag antenna capable of information transmission and reception.

2. Description of the Related Art

Recently, an RFID system has been proposed as one of radio communication systems that conduct radio communication with a communication target and has been put into practical use in various fields. In the RFID system, information reading and writing is performed in a non-contact manner between a small-sized RFID tag having the RFID tag circuit element and a reader/writer, which is a reading device and a writing device.

The RFID tag has begun to be used in various fields. An apparatus for communicating with an RFID tag that performs information reading from a plurality of RFID tag circuit elements via radio communication is already known.

Recently, with progress of practical use of the above-described RFID tag, needs for RFID tags in various types of communication status have been increased. If favorable communication is to be conducted with an apparatus for communicating with these various types of RFID tags, an operator needed to set or adjust various communication parameters to optimal values by himself for each communication. The various communication parameters to be adjusted include power and polarization phase, for example. Thus, a labor burden on the operator has been large.

### SUMMARY OF THE INVENTION

An object of the present invention is to provide an apparatus for communicating with an RFID tag that can automatically conduct radio communication using an optimal communication parameter.

In order to achieve the above-described object, according to the first invention, there is provided an apparatus for communicating with a radio frequency identification (RFID) tag comprising: an apparatus antenna configured to conduct radio communication with at least one RFID tag circuit element having an IC circuit part storing information and a tag antenna capable of transmission and reception of the information; a parameter obtainment portion configured to obtain communication parameter history information stored in a storage device and associated with tag identification information of each RFID tag circuit element; and a parameter setting portion configured to set a communication parameter for conducting information transmission and reception with the RFID tag circuit element by the apparatus antenna on the basis of the communication parameter history information obtained in the parameter obtainment portion.

### BRIEF DESCRIPTION OF THE DRAWING

FIG. 1A is a diagram illustrating an entire structure of a reader/writer, which is an apparatus for communicating with an RFID tag of the embodiment in a handheld use state.

FIG. 1B is a diagram illustrating an entire structure of the reader/writer, which is the apparatus for communicating with an RFID tag of the embodiment in a fixed use state.

FIG. 2A is a conceptual perspective view illustrating an entire outline structure of the reader/writer while an antenna is rotated in a state in which an antenna portion is rotated in a counterclockwise direction from the front direction.

FIG. 2B is a conceptual perspective view illustrating an entire outline structure of the reader/writer while the antenna is rotated in a state in which the antenna portion is rotated in a clockwise direction from the front direction.

FIG. 3A is a functional block diagram illustrating a functional configuration of the reader/writer and a cradle in the handheld use state.

FIG. 3B is a functional block diagram illustrating a functional configuration of the reader/writer and the cradle in the fixed use state.

FIG. 4 is a functional block diagram illustrating a detailed configuration of a radio frequency circuit.

FIG. 5 is a block diagram illustrating an example of a functional configuration of an RFID tag circuit element.

FIG. 6 is a flowchart illustrating a control procedure executed by a control circuit of the reader/writer.

FIG. 7 is a table conceptually illustrating data contents of a search list stored in a memory of the reader/writer or a database and including communication parameter history information associated with a tag ID of each RFID tag circuit element.

FIG. 8 is a table conceptually illustrating data contents in a state in which information corresponding to a tag ID of the RFID tag circuit element with which communication is to be conducted is specified from information in a search list.

FIG. 9 is a table illustrating data contents in a state in which a priority rank is given in a priority to combination mode.

FIG. 10 is a table illustrating data contents in a state in which a priority rank is given in a priority to parameter item mode.

### DETAILED DESCRIPTION OF THE PREFERRED EMBODIMENTS

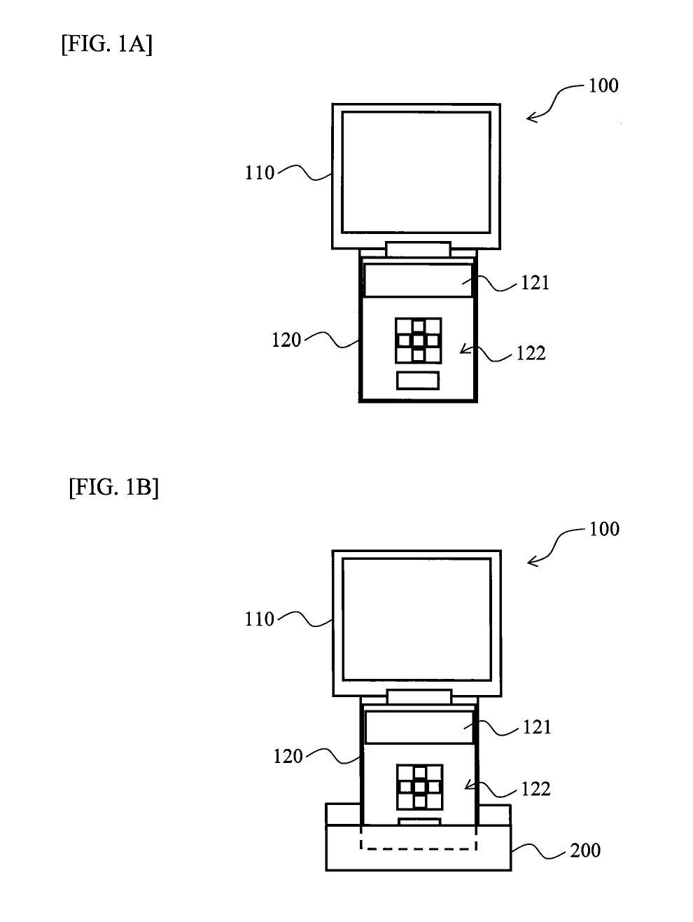

In this embodiment, as shown in FIG. 1A, if a reader/writer 100 is used without being attached to a cradle 200, that is, if it is used without being placed at a placement spot, this use is referred to as “handheld use”, and a state in the handheld use is referred to as a “handheld use state”. Also, as shown in FIG. 1B, if the reader/writer 100 is used while being attached to the cradle 200, that is, if it is used while being placed at the placement spot, this use is referred to as “fixed use”, and a state in the fixed use is referred to as a “fixed use state”.

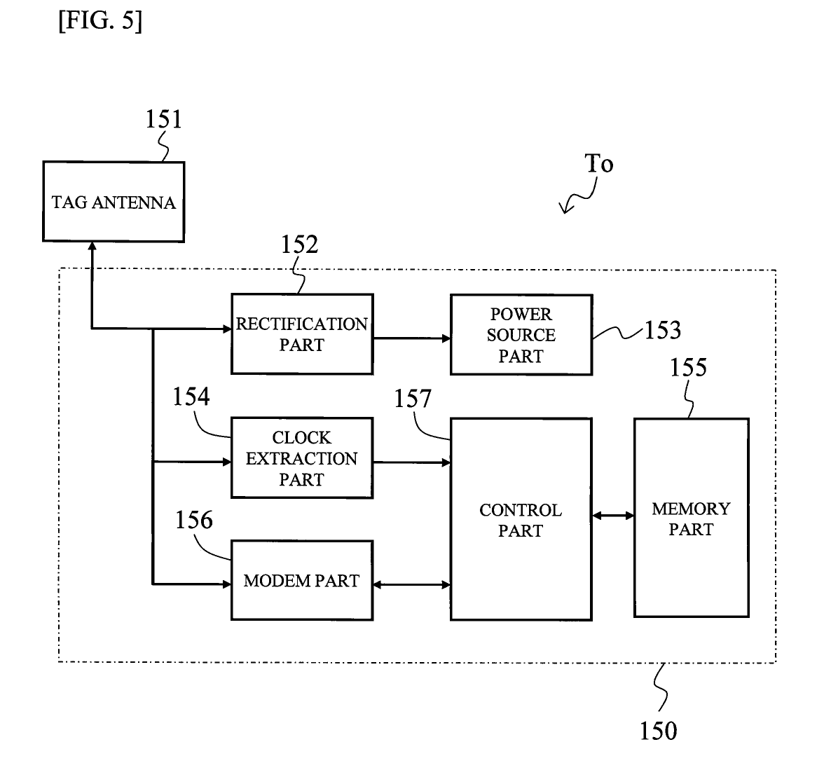

The reader/writer 100 is a handheld type apparatus for communicating with an RFID tag. The reader/writer 100 writes or reads information with respect to an RFID tag circuit element To (See FIG. 5, which will be described later) via radio communication.

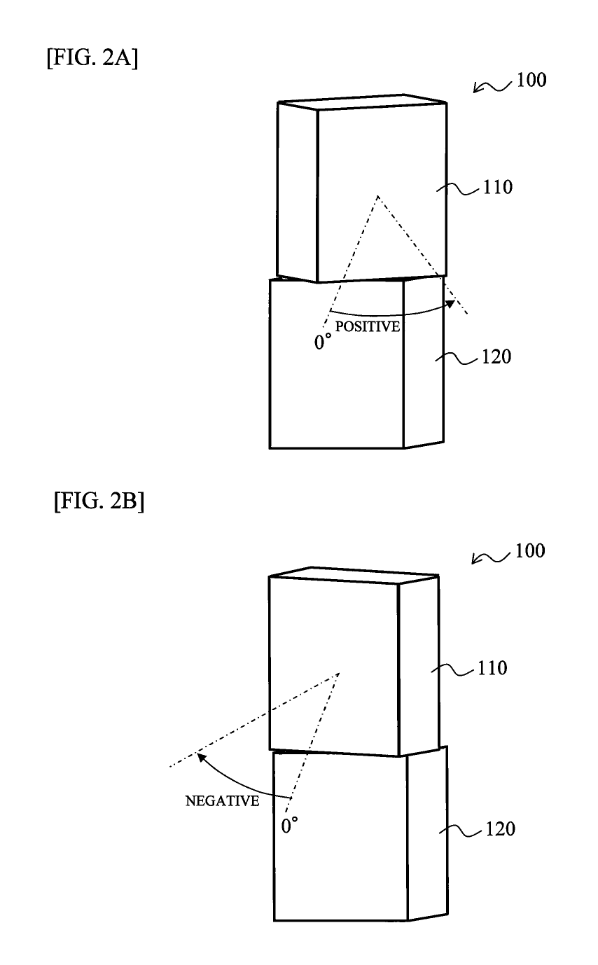

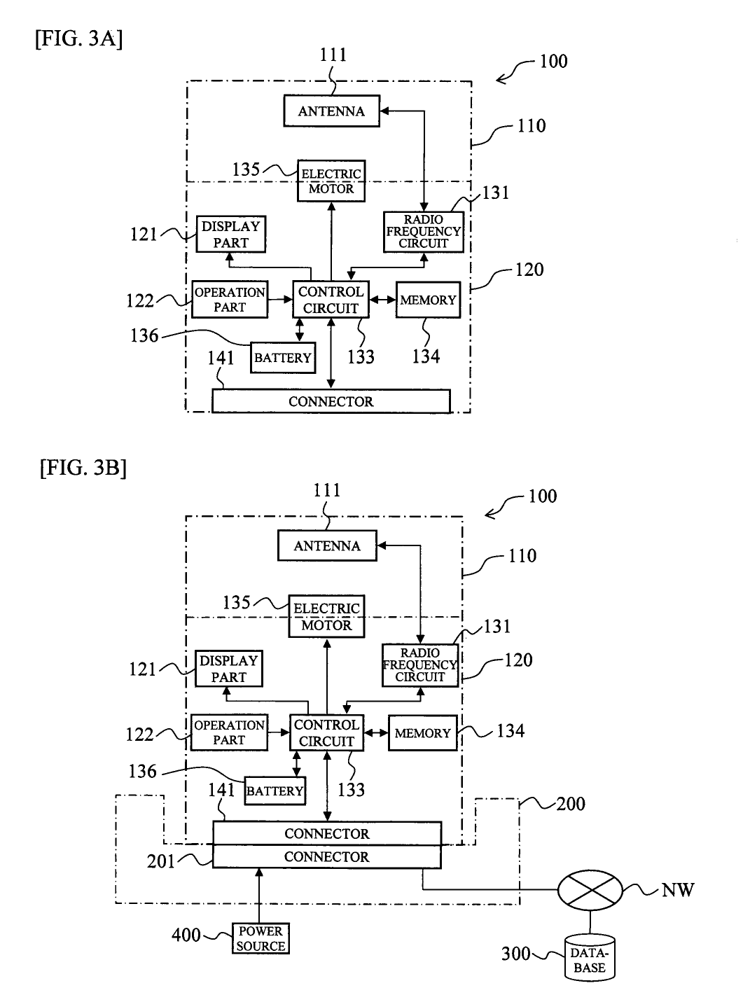

The reader/writer 100 has an antenna portion 110 and a main body portion 120. The antenna portion 110 includes a reader antenna 111 (See FIG. 3) configured to conduct radio communication. The antenna portion 110 is disposed capable of relative rotational driving with respect to the main body portion 120 (See FIG. 2, which will be described later). The main body portion 120 is disposed below the antenna portion 110. Also, the main body portion 120 has a display part 121 and an operation part 122. The display part 121 is arranged on an upper side of the main body portion 120 and displays various types of information. The operation part 122 is arranged on a lower side in the figure of the display part 121 and receives various operation inputs by an operator.

As described above, the antenna portion 110 of the reader/writer 100 is disposed capable of relative rotational driving with respect to the main body portion 120. The rotational driving of the antenna portion 110 is performed by an electric motor 135 (See FIG. 3, which will be described later) on the basis of control by a control circuit 133 (See FIG. 3, which will be described later). In this embodiment, an antenna angle in a state in which the antenna portion 110 is directed to the front direction, which is the same as the main body portion 120, that is, an antenna angle in a state shown in FIG. 1 is supposed to be 0°. Also, an antenna angle if the antenna portion 110 is rotated in a counterclockwise direction from the front as shown in FIG. 2A is supposed to be positive, while an antenna angle if the antenna portion 110 is rotated in a clockwise direction from the front as shown in FIG. 2B is supposed to be negative.

A rotary driving function of the antenna portion 110 is used particularly in a fixed use of the reader/writer 100.

As shown in FIGS. 3A and 3B, the reader/writer 100 has the display part 121, the operation part 122, the reader antenna 111 as an apparatus antenna, a radio frequency circuit 131, the control circuit 133, a memory 134, a battery 136, a connector 141, and the electric motor 135.

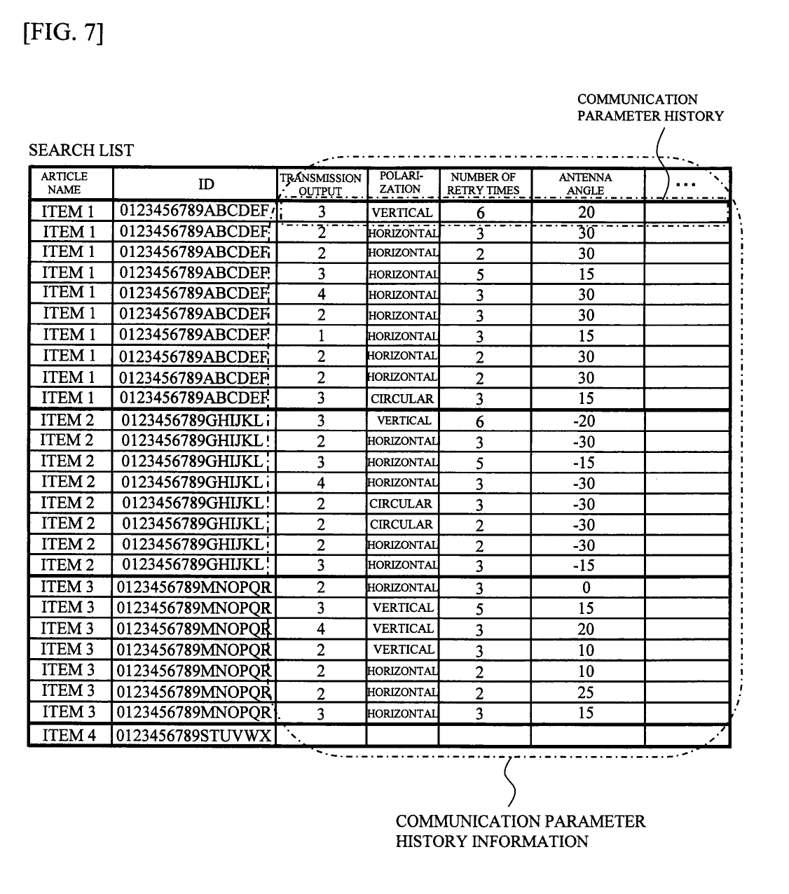

The reader antenna 111 transmits and receives a signal via radio communication with the RFID tag circuit element To, which is a communication target. The radio frequency circuit 131 accesses the IC circuit part 150 of the RFID tag circuit element To through the reader antenna 111 via radio communication and processes the signal read from the RFID tag circuit element To. The control circuit 133 controls the entire reader/writer 100 including the radio frequency circuit 131. The memory 134 stores a search list (See FIG. 7, which will be described later) containing communication parameter history information associated with tag identification information of each RFID tag circuit element, that is, a tag ID, for example. This memory 134 includes a RAM and a hard disk, for example. The battery 136 supplies power to the control circuit 133 and the display part 121, for example, in the handheld use. The connector 141 is connected to a connector 201 of the cradle 200 in the fixed use. The electric motor 135 relatively rotates and drives the antenna portion 110 with respect to the main body portion 120.

As shown in FIG. 3B, if the reader/writer 100 is attached to the cradle 200 in the fixed use, the connector 141 of the reader/writer 100 is connected to the connector 201 of the cradle 200. As a result, the control circuit 133 is connected to a database 300 of a server, for example, through a network NW. As a result, in the fixed use, the control circuit 133 can obtain the search list stored in the database 300. This search list contains the communication parameter history information associated with the tag ID of each RFID tag circuit element. The memory 134 and the database 300 configure a storage device. On the other hand, in the handheld use, the control circuit 133 can obtain the search list from the memory 134.

Also, as shown in FIG. 3B, in the fixed use, power of an external power source 400 is supplied to the reader/writer 100 through the connectors 201 and 141. As a result, the power of the external power source 400 is supplied to the control circuit 133 and the display part 121, for example. Also, while the reader/writer 100 is not being driven, the power of the external power source 400 is supplied to the battery 136. On the other hand, as shown in FIG. 3A, if the reader/writer 100 is removed from the cradle 200 in the handheld use, the power is supplied from the battery 136 to the control circuit 133 and the display part 121, for example.

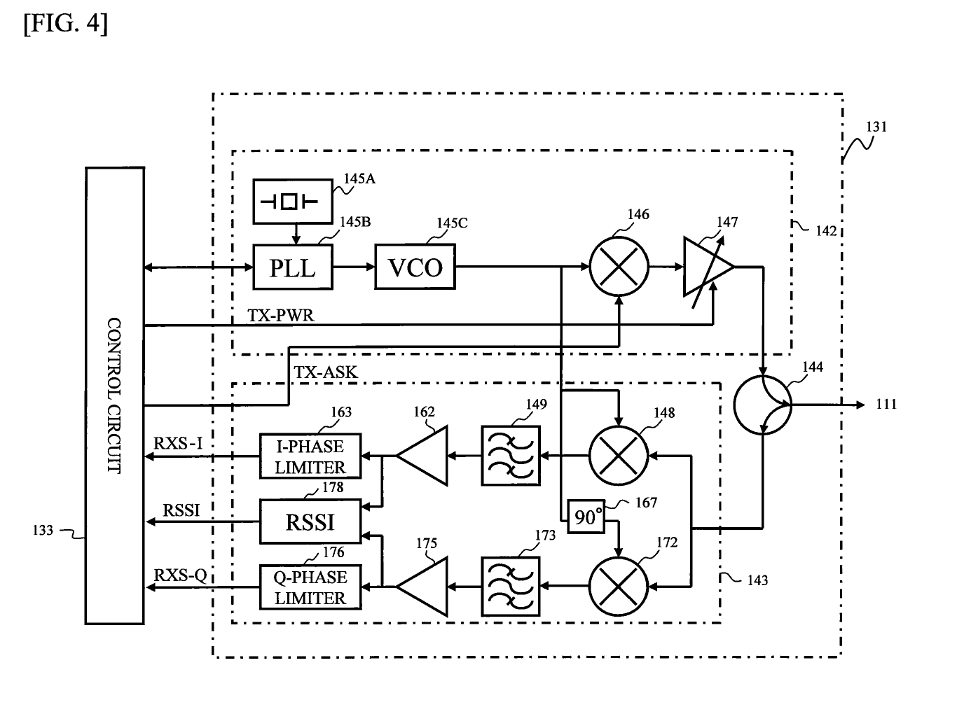

As shown in FIG. 4, the radio frequency circuit 131 accesses information in the IC circuit part 150 of the RFID tag circuit element To through the reader antenna 111. Also, the control circuit 133 of the reader/writer 100 processes the signal read from the IC circuit part 150 of the RFID tag circuit element To so as to read the information and generates various commands in order to access the IC circuit part 150 of the RFID tag circuit element To.

The radio frequency circuit 131 includes a transmitting portion 142, a receiving portion 143, and a transmit-receive splitter 144.

The transmitting portion 142 is a block that generates an interrogation wave to access RFID tag information of the IC circuit part 150 of the RFID tag circuit element To. That is, the transmitting portion 142 includes a crystal oscillator 145A, a Phase Locked Loop (PLL) 145B, a Voltage Controlled Oscillator (VCO) 145C, a transmission multiplying circuit 146, and a variable transmission amplifier 147.

The crystal oscillator 145A outputs a reference signal of a frequency. The PLL 145B and the VCO 145C generate a carrier wave with a predetermined frequency by dividing and multiplying an output of the crystal oscillator 145A by control of the control circuit 133. For the generated carrier wave, a frequency of a UHF band, a micro wave band or a short wave band is used, for example. The transmission multiplying circuit 146 modulates the carrier wave thus generated on the basis of a signal supplied from the control circuit 133. In this example, the transmission multiplying circuit 146 performs amplitude modulation on the basis of a “TX_ASK” signal from the control circuit 133. In the case of the amplitude modulation, an amplification rate variable amplifier, for example, may be used instead of the transmission multiplying circuit 146. The variable transmission amplifier 147 amplifies a modulated wave modulated by the transmission multiplying circuit 146 and generates a desired interrogation wave. The variable transmission amplifier 147 performs amplification whose amplification rate is determined by a “TX_PWR” signal from the control circuit 133. The output of the variable transmission amplifier 147 is transmitted to the reader antenna 111 through the transmit-receive splitter 144 and supplied to the IC circuit part 150 of the RFID tag circuit element To. The interrogation wave is not limited to the signal modulated as above, that is, the modulated wave but might be a mere carrier wave.

The receiving portion 143 includes an I-phase receiving signal multiplying circuit 148, an I-phase band-pass filter 149, an I-phase receiving signal amplifier 162, an I-phase limiter 163, a Q-phase receiving signal multiplying circuit 172, a Q-phase band-pass filter 173, a Q-phase receiving signal amplifier 175, and a Q-phase limiter 176. The I-phase receiving signal multiplying circuit 148 multiplies and demodulates a response wave from the RFID tag circuit element To received by the reader antenna 111 and the carrier wave thus generated. The I-phase band-pass filter 149 takes out only a signal in a required band from the output of the I-phase receiving signal multiplying circuit 148. The I-phase receiving signal amplifier 162 amplifies an output of the I-phase band-pass filter 149. The I-phase limiter 163 further amplifies the output of the I-phase receiving signal amplifier 162 and converts it to a digital signal. The Q-phase receiving signal multiplying circuit 172 multiplies the response wave from the RFID tag circuit element To received at the reader antenna 111 and the carrier wave whose phase is delayed by a phase shifter 167 by 90° after the occurrence. The Q-phase band-pass filter 173 takes out only a signal in a required band from the output of the Q-phase receiving signal multiplying circuit 172. The Q-phase receiving signal amplifier 175 amplifies an output of the Q-phase band-pass filter 173. The Q-phase limiter 176 further amplifies the output of the Q-phase receiving signal amplifier 175 and converts it to a digital signal. A signal “RXS-I” outputted from the I-phase limiter 163 and a signal “RXS-Q” outputted from the Q-phase limiter 176 are inputted into the control circuit 133 and processed.

The outputs from the I-phase receiving signal amplifier 162 and the Q-phase receiving signal amplifier 175 are also inputted into a Received Signal Strength Indicator (RSSI) circuit 178 and a signal “RSSI” indicating the intensity of these signals is inputted into the control circuit 133. With the arrangement, the reader/writer 100 demodulates the response wave from the RFID tag circuit element To by I-Q quadrature demodulation.

As shown in FIG. 5, the RFID tag circuit element To has the tag antenna 151 and the IC circuit part 150.

The IC circuit part 150 includes a rectification part 152, a power source part 153, a clock extraction part 154, a memory part 155, a modem part 156, a random number generator 158 (details will be described later), and a control part 157. The rectification part 152 rectifies the interrogation wave received by the tag antenna 151. The power source part 153 accumulates energy of the interrogation wave rectified by the rectification part 152 and uses the energy as a driving power source of the RFID tag circuit element To. The clock extraction part 154 extracts a clock signal from the interrogation wave received by the tag antenna 151 and supplies the signal to the control part 157. The memory part 155 stores a predetermined information signal. The control part 157 controls operations of the RFID tag circuit element To through the memory part 155, the clock extraction part 154, and the modem part 156, for example.

The modem part 156 demodulates the interrogation wave from the reader antenna 3 of the reader 1, received by the tag antenna 151 and also modulates a reply signal from the control part 157 and transmits it as a response wave, that is, a signal including a tag ID, from the tag antenna 151.

The control part 157 interprets a received signal demodulated by the modem part 156 and generates a reply signal on the basis of the information signal stored in the memory part 155. The modem part 156 transmits the reply signal through the tag antenna 151.

Here, the most distinctive characteristic of the reader/writer 100 of this embodiment is that communication parameter history information on the past successful radio communication with the RFID tag circuit element To is stored in the memory 134 as the storage device or the database 300 in association with the tag ID of the RFID tag circuit element To. As a result, if radio communication is to be conducted with the RFID tag circuit element To next time, the optimal communication parameter can be automatically set using the stored communication parameter history information. The details will be described below.

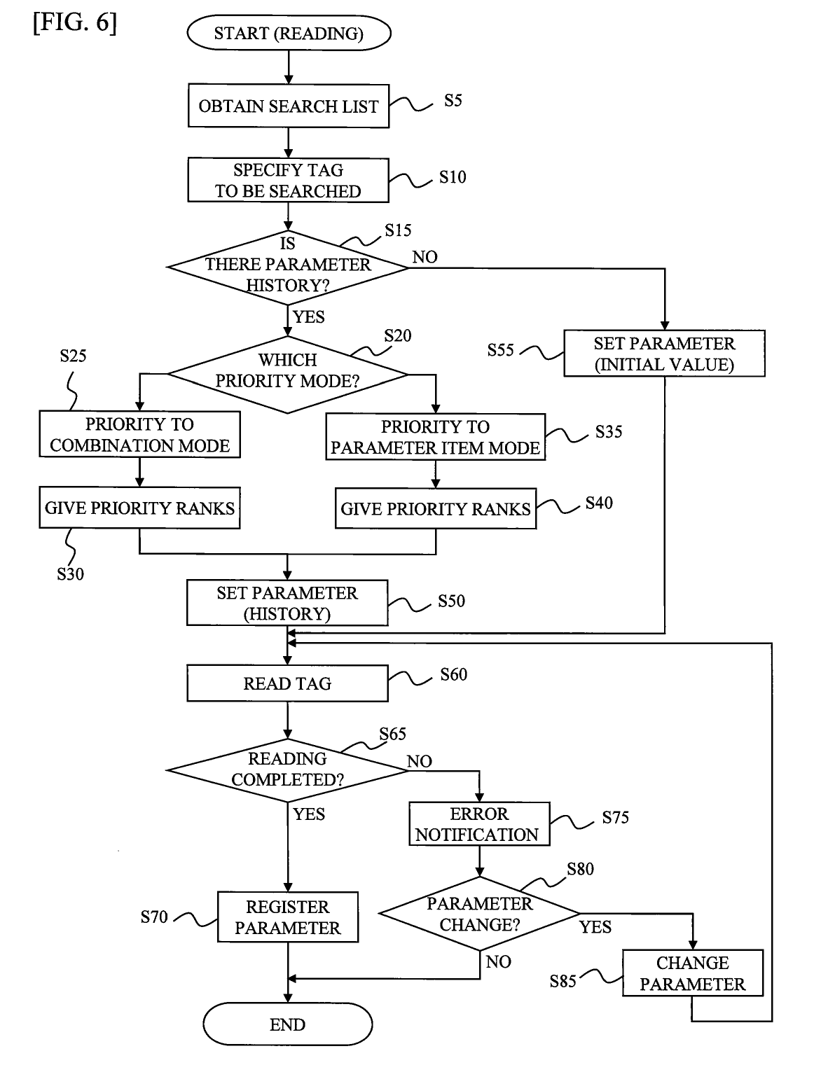

Using FIG. 6, a case to read information from the RFID tag circuit element To by the reader/writer 100 will be described. After the reader/writer 100 is powered on or an operation to start reading processing of the RFID tag circuit element To is performed in the operation part 122, for example, the control circuit 133 is at a “START” position to start this flow.

First at Step S5, the control circuit 133 searches and obtains the search list containing the communication parameter history information associated with the tag ID of each RFID tag circuit element. Specifically, the control circuit 133 searches the memory 134 if the reader/writer 100 is in the handheld use state. Also, the control circuit 133 searches and obtains the search list in the database 300 connected through the cradle 200 and the network NW if the reader/writer 100 is in the fixed use state.

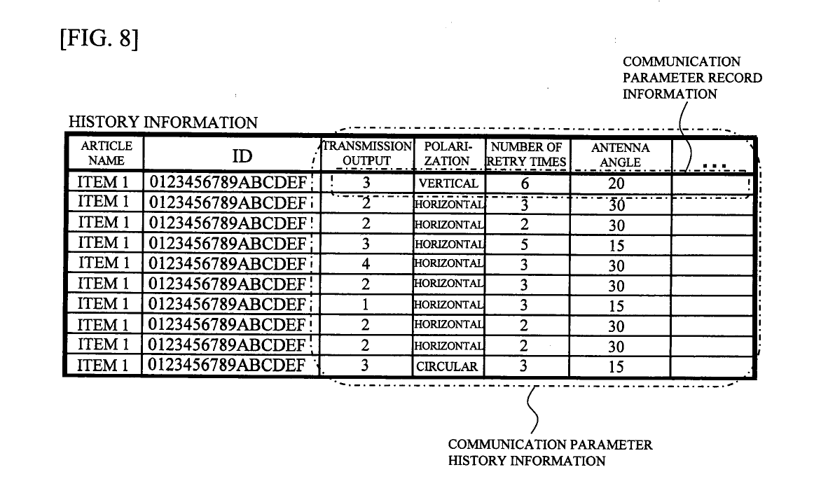

At Step S10, the control circuit 133 specifies the tag ID of the RFID tag circuit element To with which the communication is to be conducted in the tag IDs of the plurality of RFID tag circuit elements To included in the obtained search list (See FIG. 8, which will be described later). If there is communication history with the plurality of RFID tag circuit elements To included in the search list, the control circuit 133 also specifies communication parameter record information associated with the tag ID as a communication target in the communication parameter record information associated with each of the tag IDs. The RFID tag circuit element To as the communication target is selected from the plurality of RFID tag circuit elements To included in the obtained search list displayed on the display part 121, for example, by an operator using the operation part 122.

At Step S15, the control circuit 133 determines if the communication parameter history information is added to the tag ID of the RFID tag circuit element To as the communication target specified at Step S10 or not. That is, if there is a record of the past successful communication with the RFID tag circuit element To as the communication target, since the communication parameter history information at that time is added to the tag ID and registered in the search list (Step S70, which will be described later), the determination is satisfied. On the other hand, if there is no past communication record, or if there is no successful communication record even if communication has been conducted, since the communication parameter history information is not added to the tag ID, the determination is not satisfied. If the communication parameter history information is added, the determination is satisfied, and the routine goes to Step S20.

At Step S20, the control circuit 133 determines a priority mode. In this embodiment, a “priority to combination” mode and a “priority to parameter item” mode are prepared, and which of the priority modes is used for parameter setting is set by the operator in advance. Alternatively, the operator may select the priority mode at each communication. In the “priority to combination” mode, a priority rank is given to each communication parameter record information (See FIG. 7, which will be described later) relating to a single session of communication record with the RFID tag circuit element To as the communication target specified at Step S10. The priority ranks are given in order from the communication parameter history information with higher appearance frequency in all the communication parameter history information relating to the RFID tag circuit element To. The single session of the communication record means the communication record with the individual RFID tag circuit element To if communication is conducted with the plurality of RFID tag circuit elements To in a single session. The same applies to the following.

On the other hand, in the “priority to parameter item” mode, the priority rank is given to each communication parameter item relating to a single session of the communication record with the RFID tag circuit element To as the communication target specified at Step S10. The priority ranks are given in order from the communication parameter item with higher appearance frequency in all the communication parameter items of all the communication parameter history information relating to the RFID tag circuit element To.

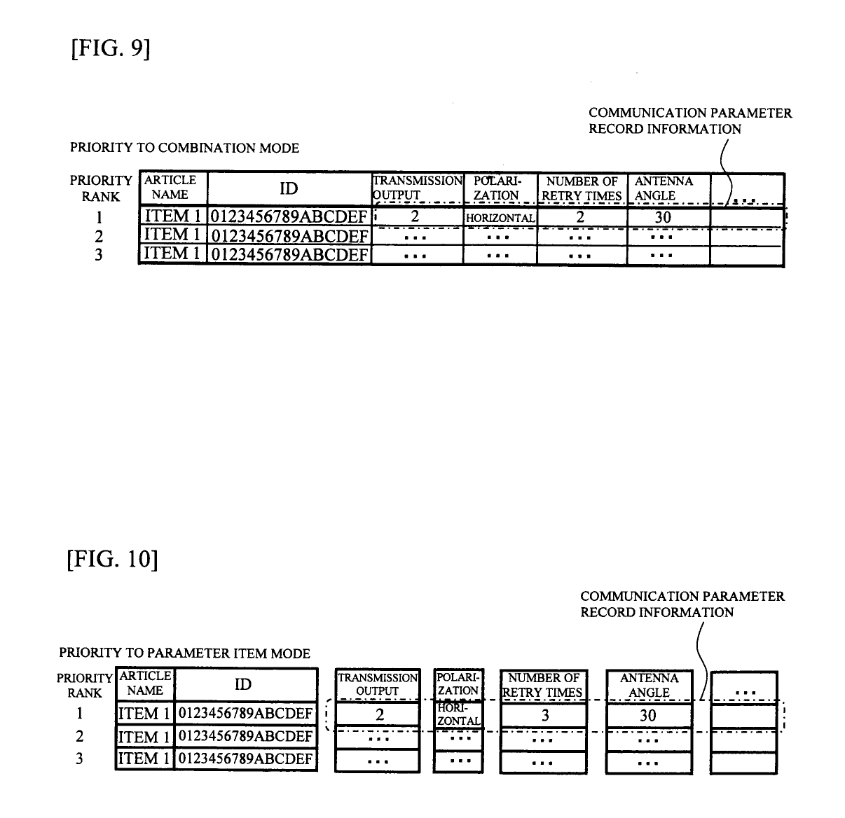

If the “priority to combination” mode is set, the control circuit 133 moves to the “priority to combination” mode at Step S25. After that, at Step S30, the control circuit 133 gives priority ranks to each communication parameter record information in order from the higher appearance frequency in the communication parameter history information corresponding to the RFID tag circuit element To as the communication target (See FIG. 9, which will be described later). On the other hand, if the “priority to parameter item” mode is set, the control circuit 133 moves to the “priority to parameter item” mode at Step S35. After that, at Step S40, the control circuit 133 gives priority ranks to each communication parameter item as a parameter element relating to the communication record with the RFID tag circuit element To in order from the higher appearance frequency in the communication parameter history information corresponding to the RFID tag circuit element To as the communication target (See FIG. 10, which will be described later).

At Step S50, the control circuit 133 sets communication parameters such as a power for performing information transmission and reception with the RFID tag circuit element To with which the communication is to be conducted, a polarization phase, the number of retry times, and an antenna angle, for example. At that time, the control circuit 133 sets the communication parameters on the basis of the communication parameter record information with the highest priority rank given at Step S30 or on the basis of the communication parameter history information made up of a combination of communication parameter items with the highest priority rank given at Step S40. At this time, a control signal is outputted to the electric motor 135, and the antenna portion 110 is rotated and driven so that the antenna angle becomes the set angle. Then, the routine goes to Step S60.

If the communication parameter history information has not been given at the preceding Step S15, the determination is not satisfied, and the routine goes to Step S55. At Step S55, the control circuit 133 sets the communication parameters to initial values determined in advance. Then, the routine goes to Step S60.

At step S60, the control circuit 133 sets the various communication parameters including the power, the polarization phase, and the number of retry times to the values set at Step S50 or Step S55 and transmits a control signal to the transmitting portion 142 of the radio frequency circuit 131. As a result, a carrier wave in the UHF band at 915 MHz, for example, is generated from the crystal oscillator 145A, the PLL 145B, and the VCO 145C. Then, on the basis of the control signal, the generated carrier wave is modulated and amplified, and a reading signal is transmitted to the IC circuit part 150 of the RFID tag circuit element To through the transmit-receive splitter 144 and the reader antenna 111.

At Step S65, the control circuit 133 determines if a response signal in response to the reading signal has been received from the IC circuit part 150 of the RFID tag circuit element To that transmitted the reading signal or not. If the response signal has not been received, at Step S65, the control circuit 133 performs retries for the number of retry times in the communication parameter set at Step S50 or Step S55. If the response signal is received in the retry and reading of the tag information is completed, the determination at Step S65 is satisfied, and the routine goes to Step S70. At Step S70, the control circuit 133 adds the communication parameter set at Step S50 or Step S55 as communication parameter record information to a corresponding portion in the search list obtained at the preceding Step S5. Then, the control circuit 133 registers the search list after the addition to the memory 134 if the reader/writer 100 is in the handheld use state or in the database 300 through the cradle 200 and the communication network NW if the reader/writer 100 is in the fixed use state. Then, this flow is finished. On the other hand, if the response signal has not been received in the retry, the determination at Step S65 is not satisfied, and the routine goes to Step S75.

At Step S75, the control circuit 133 outputs a control signal to the display part 121. As a result, the display part 121 displays that the reading of the tag information was not successful.

At Step S80, the control circuit 133 determines if the communication parameter set at Step S50 or Step S55 is to be changed or not. For that purpose, a display prompting an input by an operator such as “Parameter is to be changed?” is made on the display part, for example, and the determination is made on the basis of a signal inputted by the operator using the operation part 122. Alternatively, whether or not the parameter is to be changed in the case of communication failure may be set in advance. If the parameter is to be changed, the determination is satisfied, and the routine goes to Step S85, where the control circuit 133 changes the communication parameter and the routine returns to Step S60. This communication parameter change is performed by manual input by the operator using the operation part 122. Alternatively, a change amount set in advance for each parameter item may be automatically changed by the control circuit 133. Moreover, the control circuit 133 may use the parameter on the subsequent rank in the priority ranks given at Step S30 or Step S40. On the other hand, if the parameter change is not to be performed at Step S80, this flow is finished.

Though not particularly shown in the flowchart, when information is to be written in the RFID tag circuit element To, too, the above-described method is used. That is, the control circuit 133 obtains and sets the communication parameter if there is parameter history information or sets the communication parameter to an initial value if there is no parameter history information. Then, the control circuit 133 writes information using the set communication parameter.

Step S5 functions as a parameter obtainment portion described in each claim, Step S10 functions as a parameter specification portion, and Step S50 further functions as a parameter configuring portion and also as a parameter setting portion. Step S70 functions as a parameter storage process portion.

Step S30 and Step S40 function as a priority rank giving portion.

The flowchart does not limit the present invention to the procedure shown in the flow but addition and deletion of the procedures or change of the order, for example, may be made within a range not departing from the gist and technical scope of the invention.

Contents of the search list will be described using FIG. 7.

In an example shown in FIG. 7, tag IDs of four types of the RFID tag circuit elements To relating to “items 1 to 4” as search targets are included in the search list. In these four tag IDs, the tag IDs of the RFID tag circuit elements To relating to the “items 1 to 3” have communication records in the past with respect to the RFID tag circuit elements To, and the communication parameter history information is added to each. On the other hand, the tag ID of the RFID tag circuit element To relating to the “item 4” does not have any communication record in the past with respect to the RFID tag circuit element To, and the communication parameter history information is not added.

To the RFID tag circuit elements To relating to the “items 1 to 3”, the communication parameter record information relating to one session of communication record with each RFID tag circuit element To is added for each communication session in the past. As a result, the communication parameter history information corresponding to the tag ID of each RFID tag circuit element To has a plurality of pieces of the communication parameter record information, respectively. Each communication parameter record information includes information on the power, the polarization phase, the number of retry times in successful communication, that is, the retry times, and the antenna angle. The parameter relating to the antenna angle may be used only if the reader/writer 100 is used in the fixed manner. Also, the communication parameter items of the communication parameter record information is not limited to the above, but parameter items other than the above such as a communication protocol, a communication speed, and transmission power, for example, may be included.

FIG. 8 shows a case in which the RFID tag circuit element To relating to the “item 1” is searched. As shown in FIG. 8, the tag ID of the RFID tag circuit element To relating to the “item 1” and the communication parameter history information associated with that and configured by a plurality of pieces of the communication parameter record information are extracted from the search list shown in FIG. 7.

In an example shown in FIG. 9, the priority ranks are given in the order from the higher appearance frequency of the communication parameter record information in the communication parameter history information shown in FIG. 8 for each piece of the communication parameter record information. In this case, on the basis of the communication parameter record information in the highest stage in the list, which is the first priority rank, the communication parameter is set at Step S50.

In an example shown in FIG. 10, the priority ranks are given in the order from the higher appearance frequency of the communication parameter item in the communication parameter history information shown in FIG. 8 for each parameter item. In this case, the communication parameter record information is configured by combining the communication parameters on the highest stage, which is the first priority rank in each communication parameter item. Then, on the basis of the configured communication parameter record information, the communication parameter is set at Step S50.

In the above-described embodiment, the communication parameter history information relating to the communication with the RFID tag circuit element To is stored in the memory 134 or the database 300 in a form associated with the tag ID of each RFID tag circuit element To. When radio communication is to be conducted, the communication parameter history information stored in the memory 134 or the database 300 is obtained. The communication parameter used when radio communication is conducted with the RFID tag circuit element To through the apparatus antenna 111 is set on the basis of the communication parameter history information thus obtained.

In the above-described embodiment, the communication parameter history information when the radio communication with the RFID tag circuit element To was successful in the past is stored in the memory 134 or the database 300. On the basis of the stored communication parameter history information, the communication parameter optimal for the radio communication with the RFID tag circuit element To can be automatically set.

As a result, the operator can conduct the radio communication automatically using the optimal communication parameter without any operation such as setting or adjustment of the communication parameter, for example, by himself. Therefore, convenience for the operator can be improved.

Also, particularly in this embodiment, the communication parameter history information in the search list stored in the memory 134 or the database 300 includes at least one of the communication parameter record information relating to a single session of communication record with the RFID tag circuit element To. This communication parameter history information is obtained from the memory 134 or the database 300, and then, the communication parameter record information associated with the tag ID of the RFID tag circuit element To with which the communication is to be conducted is specified in the communication parameter record information included in the communication parameter history information.

As described above, the communication parameter optimal for the RFID tag circuit element To as the communication target can be automatically set. Particularly, even if the communication parameter history information configured by a plurality of pieces of the communication parameter record information associated with the tag IDs of a plurality of the RFID tag circuit elements To, respectively, is stored in the memory 134 or the database 300, the communication parameter optimal for the communication can be reliably set from them.

Also, particularly in this embodiment, the communication parameter record information when the radio communication with the RFID tag circuit element To was successful is stored in the memory 134 or the database 300. As a result, the communication parameter record information at the successful radio communication can be stored as the communication parameter history information for the subsequent radio communication in the memory 134 or the database 300.

Also, particularly in this embodiment, if the reader/writer 100 is in the fixed use state, the communication parameter record information is stored in the cradle 200 and the database 300 through the network line NW. As a result, when radio communication is to be conducted with the RFID tag circuit element To corresponding to the stored communication parameter record information, the communication parameter history information stored in the database 300 is obtained. Then, on the basis of the obtained communication parameter history information, the communication parameter optimal for the radio communication with the RFID tag circuit element To is automatically set. Also, by registering the communication parameter history information in the database 300 outside the apparatus as above, as compared with the case in which the memory is disposed inside the apparatus of the reader/writer 100, increase of storage capacity and replacement are easier.

Also, particularly in this embodiment, if the reader/writer 100 is in the handheld use state, the communication parameter record information is stored in the memory 134 disposed in the reader/writer 100. As a result, when the radio communication is to be conducted with the RFID tag circuit element To corresponding to the stored communication parameter record information, the communication parameter history information stored in the memory 134 is obtained. Then, on the basis of the obtained communication parameter history information, the communication parameter optimal for the radio communication with the RFID tag circuit element To is automatically set. By registering the communication parameter history information in the memory in the apparatus as above, there is no need to separately dispose a storage device outside the reader/writer 100. As a result, control reliability and rapidness of the communication processing are improved.

Also, particularly in this embodiment, priority ranks relating to communication parameter setting are given in relation with the communication parameter history information including a plurality of pieces of the parameter record information. As a result, the priority ranks can be given according to a use status or application of the operator, and the communication parameter can be automatically set using the communication parameter record information according to the given priority ranks. As a result, the optimal communication parameter can be set more reliably, and convenience is improved.

Also, particularly in this embodiment, in the priority to combination mode, the priority ranks are given to each piece of the communication parameter record information according to the appearance frequency of the communication parameter record information in the communication parameter history information. By using the communication parameter record information with high frequency in the communication parameter history information, the optimal communication parameter can be set automatically.

Also, particularly in this embodiment, in the priority to parameter item mode, the priority ranks are given to each communication parameter item according to the appearance frequency of the communication parameter item in the communication parameter history information. By configuring and using the communication parameter record information through combination of parameter elements with high frequency in the communication parameter history information, the optimal communication parameter can be automatically set.

Also, particularly in this embodiment, in the plurality of pieces of the communication parameter record information relating to the specified RFID tag circuit elements as communication targets, the communication parameter in communication is set according to the given priority ranks. As a result, the communication parameter is automatically set using the communication parameter record information with high priority. As a result, the communication parameter can be further reliably optimized.

Also, particularly in this embodiment, after or when the communication parameter history information is obtained from the memory 134 or the database 300, the priority ranks are given to the communication parameter history information. As a result, according to the priority ranks, the communication parameters in communication are configured and set. As a result, the communication parameter can be set reflecting the latest communication parameter history information when the communication parameter history information is obtained.

The present invention is not limited to the above-described embodiment but capable of various variations within a range not departing from its gist and technical scope. The variations will be described below in order.

(1) Variation of the Communication Parameter Item

In the above-described embodiment, the communication parameter items configuring the communication parameter record information are power, polarization phase, retry times, and antenna angle. However, not limited to them, parameters other than the above may be included in the communication parameter items. The variations will be described below in order.

(i) RFID Tag Circuit Element Searched Around the Search Target

In the above-described embodiment, the case in which a search is made in a so-called single search mode was described. In the single search mode, only one RFID tag circuit element To with which communication is to be conducted is specified from the search list. Then, communication is continued so as to inquire if the RFID tag circuit element To as the search target is present in a range of a communicable area of the reader/writer 100 or not. However, not limited to this method, a search may be made in a search mode such as a multi search mode or a list-up mode, for example.

In the multi search mode, a plurality of RFID tag circuit elements To with which communication is to be conducted are specified from the search list. Then, communication is continued so as to inquire if the plurality of search targets are present in the range of the communicable area of the reader/writer 100 or not.

In the list-up mode, unlike the single search mode or multi search mode, specification of the search target, that is, specification of the tag ID is not made. Then, the radio communication is conducted with unspecific RFID tag circuit elements To present in the range of the communicable area of the reader/writer 100, and all the detected RFID tag circuit elements To are listed up.

In this variation, if the plurality of the RFID tag circuit elements To are detected by making a search in the list-up mode, the communication parameter history information of each RFID tag circuit element To is registered in a form including the tag IDs of the other RFID tag circuit elements To around it detected at the same time.

If one RFID tag circuit element To as the search target is to be searched in the plurality of the RFID tag circuit elements To detected as above, first, the search is made in the list-up mode. At that time, if the RFID tag circuit elements To around it are detected, since it is inferred that the RFID tag circuit element To as the search target is present in the vicinity, the mode is changed to the single search mode. That is, such automatic selection of mode is made possible.

This variation is particularly effective if the position of the detected plurality of RFID tag circuit elements To are fixed, that is, if they are used as so-called location tags.

(ii) Order of Detection of RFID Tag Circuit Element in Multi Search

In this variation, if the plurality of RFID tag circuit elements To are detected by making a search in the multi search mode, the communication parameter history information of each RFID tag circuit element To is registered in the form including the information relating to the detection order of the RFID tag circuit element To. As a result, if the plurality of RFID tag circuit elements To are to be searched in the multi search mode next time, the search can be made in the optimal order by making a search in the above-described detection order. As a result, a smooth and effective search can be made.

(iii) Search Time and Date

In this variation, the communication parameter history information of each RFID tag circuit element To is registered in the form including time and date information when the RFID tag circuit element To is detected. As a result, at the next search, fine parameter setting is made possible by giving time-series priority conditions. Specifically, in the communication parameter history information of the RFID tag circuit element To as the search target, it is possible to use the communication parameter history information with the relatively new time and date with priority or to use the communication parameter history information belonging to a predetermined time zone with priority, for example.

(2) If the Plurality of Pieces of Parameter Record Information are Specified According To the Priority Rank:

In the above-described embodiment, only one piece of the communication parameter record information with the highest given priority rank or of the communication parameter record information configured by combining the communication parameters with the highest given priority ranks is specified. Then, on the basis of the specified information, the communication parameter is set. However, not limited to this method, a plurality of pieces of the communication parameter record information to be used in the communication may be specified according to the given priority ranks such as the first to third priority ranks, for example. As a result, the communication parameter record information is determined from the specified plurality of pieces of the communication parameter record information by selection according to the intention of the operator. As a result, parameter setting reflecting the intension of the operator can be made.

(3) If the Priority Rank is Given at Update of the Communication Parameter:

In the above-described embodiment, the priority rank is given to the communication parameter history information after the communication parameter history information is obtained from the memory 134 or the database 300. However, the present invention is not limited to that method. That is, the priority rank may be given to the communication parameter history information stored in the memory 134 or the database 300, for example. In this case, if the radio communication is to be conducted, the communication parameter history information to which the priority rank is given is obtained from the memory 134 or the database 300, and the communication parameter in communication can be set according to the priority rank. As a result, when the communication parameter history information is obtained, the communication parameter can be set smoothly and rapidly after information obtainment according to the given priority rank. Also, when the communication parameter record information is registered in the memory 134 or the database 300, the priority rank can be given at appropriate timing such as at update of data, for example.

(4) Parameter Setting in the Multi Search Mode and List-Up Mode

In the above-described embodiment, the communication parameter is set on the basis of the priority rank from the individual communication history of each RFID tag circuit element To. However, the present invention is not limited to this method. That is, in the multi search mode or the list-up mode, the communication parameter may be set as follows.

That is, with regard to the items such as transmission power and the retry times, for example, a maximum value in the communication history with respect to the plurality of RFID tag circuit elements To may be employed. Also, a predetermined variable range may be set from the communication history instead of setting of the communication parameter to a value of one point so that the operator can make adjustment in the variable range.

Moreover, for each RFID tag circuit element To, the present invention is not limited to registration of only the communication parameter history information for the single search mode as in the above-described embodiment. That is, for each RFID tag circuit element To, the communication parameter history information for the multi search mode or list-up mode may be also registered at the same time. As a result, the communication parameter history information to be used can be switched according to the search mode.

(5) Others

In the above-described embodiment, the case in which the present invention is applied to the handheld apparatus for radio communication was described as an example, but not limited to that. That is, the present invention may be applied to an installed type apparatus for radio communication that is fixedly installed at a predetermined position.

Also, in the above-described embodiment, if the reader/writer 100 is in the handheld use state, the communication parameter history information is registered in the memory 134 and the information is obtained from the memory 134 at a search. In the fixed use state, the communication parameter history information is registered in the database 300 and obtained from the database 300 at a search. However, the present invention is not limited to this method. That is, in either of the handheld use state and fixed use state, for example, the communication parameter history information may be registered in the memory 134 and also obtained from the memory 134 at a search. Also, in either of the handheld use state and fixed use state, for example, the communication parameter history information may be registered in the database 300 and also obtained from the database 300 at a search. In this case, information transmission and reception with respect to the database 300 in the handheld use state may be performed through a wireless LAN, for example.

In the above-described embodiment, the communication parameter record information in successful communication is stored in the memory 134 or the database 300, but not limited to that method. That is, to the contrary, the communication parameter record information when the radio communication with the RFID tag circuit element To failed in the past may be stored in the memory 134 or the database 300. In this case, the stored inappropriate communication parameter is automatically eliminated in the subsequent communication, and a favorable communication parameter is set.

Other than those described above, the methods of the above-described embodiment and the variations may be combined as appropriate for use.

Arrows shown in FIGS. 3, 4, and 5, for example, only indicate one example of a flow of signals and do not limit the flow direction of the signals.

Though not specifically exemplified, the present invention should be put into practice with various changes made in a range not departing from its gist.

What is claimed is:

1. An apparatus for communicating with a radio frequency identification (RFID) tag comprising:
an apparatus antenna configured to conduct radio communication with at least one RFID tag circuit element having an IC circuit part storing information and a tag antenna capable of transmission and reception of the information;
a parameter obtainment portion configured to obtain communication parameter history information stored in a storage device and associated with tag identification information of each RFID tag circuit element; and
a parameter setting portion configured to set a communication parameter for conducting information transmission and reception with said RFID tag circuit element by said apparatus antenna on the basis of said communication parameter history information obtained in said parameter obtainment portion.

2. The apparatus according to claim 1, wherein:
said parameter obtainment portion obtains said communication parameter history information including at least one piece of communication parameter record information relating to a single session of communication record with said RFID tag circuit element; and
the apparatus further comprises a parameter specification portion configured to specify said communication parameter record information associated with tag identification information of said RFID tag circuit element with which communication is to be conducted among said communication parameter record information included in said communication parameter history information obtained in said parameter obtainment portion.

3. The apparatus according to claim 2, further comprising:
a parameter storage process portion configured to store said communication parameter record information when radio communication with said RFID tag circuit element is successful in said storage device.

4. The apparatus according to claim 3, further comprising:
a priority rank giving portion configured to give a priority rank relating to communication parameter setting in said parameter setting portion in connection with said communication parameter history information including a plurality of pieces of said communication parameter record information.

5. The apparatus according to claim 4, wherein:
said priority rank giving portion gives the priority rank to each communication parameter record information according to an appearance frequency in said communication parameter history information.

6. The apparatus according to claim 4, wherein:
said communication parameter record information includes at least one parameter element; and
said priority rank giving portion gives the priority rank to each of said parameter elements according to an appearance frequency in said communication parameter history information.

7. The apparatus according to claim 4, wherein:
said parameter setting portion has a parameter structuring portion configured to construct said communication parameter in communication according to the priority rank given by said priority rank giving portion in a plurality of pieces of said communication parameter record information relating to one said RFID tag circuit element specified in said parameter specification portion.

8. The apparatus according to claim 7, wherein:
said parameter structuring portion constructs a plurality of pieces of said communication parameter record information to be used in communication according to the priority rank given in said priority rank giving portion.

9. The apparatus according to claim 4, wherein:
after said communication parameter history information is obtained by said parameter obtainment portion from said storage device, said priority rank giving portion gives said priority rank to the obtained communication parameter history information.

10. The apparatus according to claim 4, wherein:
said priority rank giving portion gives the priority rank to said communication parameter history information stored in said storage device.
